(19) United States
(12) Patent Application Publication
(10) Pub. No.: US 2016/0267168 A1
(43) Pub. Date: Sep. 15, 2016

(54) RESIDUAL DATA IDENTIFICATION

(71) Applicant: HEWLETT PACKARD ENTERPRISE DEVELOPMENT LP, Houston, TX (US)

(72) Inventors: George H. Forman, Port Orchard, WA (US); Renato Keshet, Haifa (IL)

(21) Appl. No.: 15/033,181

(22) PCT Filed: Dec. 19, 2013
(86) PCT No.: PCT/US2013/076538

§ 371 Date: Apr. 29, 2016

(51) Int. Cl. G06F 17/30; G06N 99/00

(52) U.S. Cl. CPC G06F 17/30598; G06F 17/3053; G06N 99/005

(57) ABSTRACT

A technique for residual data identification can include receiving a plurality of data instances in a multi-class training data set that are d as belonging to recognized categories, receiving a plurality of data instances a first unlabeled data set, and receiving a plurality of data instances in a second unlabeled data set A technique for residual data identification can include labeling the plurality of data instances in the multi-class training data set as negative data instances. A technique for residual data identification can include labeling the plurality of data instances in the first unlabeled data set as positive data instances. A technique for residual data identification can include training a classifier with the labeled negative data instances and the labeled positive data instances. A technique for residual data identification can include applying the classifier to identify residual data instances in the second unlabeled data set.

### BACKGROUND

Data sets can be divided into a number of categories. Categories can describe similarities between data instances in data sets. Categories can be used to analyze data sets. The discovery of new similarities between data instances can lead to the creation of new categories.

### BRIEF DESCRIPTION OF THE DRAWINGS

FIG. 1 illustrates a block diagram of an example of a computing device according to the present disclosure.

FIG. 2A illustrates a diagram of an example of a number of data sets according to the present disclosure.

FIG. 2B illustrates a diagram of an example of a number of data sets scoring to the present disclosure.

FIG. 3 illustrates a block diagram of an example of system for residual data identification according to the present disclosure.

FIG. 4 illustrates a flow diagram of an example of a method for residual data identification according to the present disclosure.

### DETAILED DESCRIPTION

Residual data includes data instances that do not belong to any recognized category of data instances identifying residual data instances can include training a classifier with negative data instances and positive data instances. The negative data instances can include a plurality of data instances in a multi-class training data set that are labeled as belonging to recognized categories. As used herein, a class is intended to be synonymous with a category. The positive data instances can be a plurality of data instances in a first unlabeled data set. Identifying residual data instances can also include applying the classifier to identify residual data instances in a second unlabeled data set.

A multi-class training data set can include a plurality of data instances that are divided into a number of recognized categories. The plurality of data instances in the number of recognized categories can be considered as negative data instances in training a classifier. The classifier can then be used to identify residual data instances. That is, the classifier can be used to identify data instances that do not belong to the recognized categories.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

The specification examples provide a description of the applications and use of the system and method of the present disclosure. Since any examples can be made without departing from the spirit and scope of the system and method of the present disclosure, this specification sets forth some of the many possible example configurations and implementations.

As used herein, “a” or “a number of” something can refer to one or more such things. For example, “a number of widgets” can refer to one or more widgets.

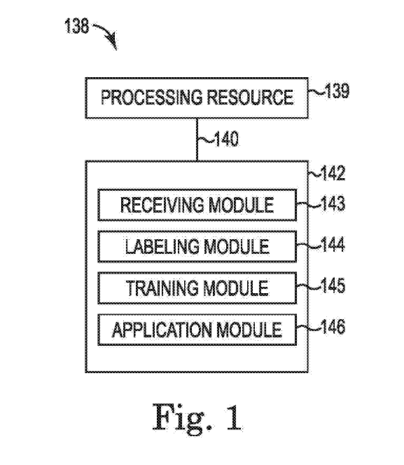

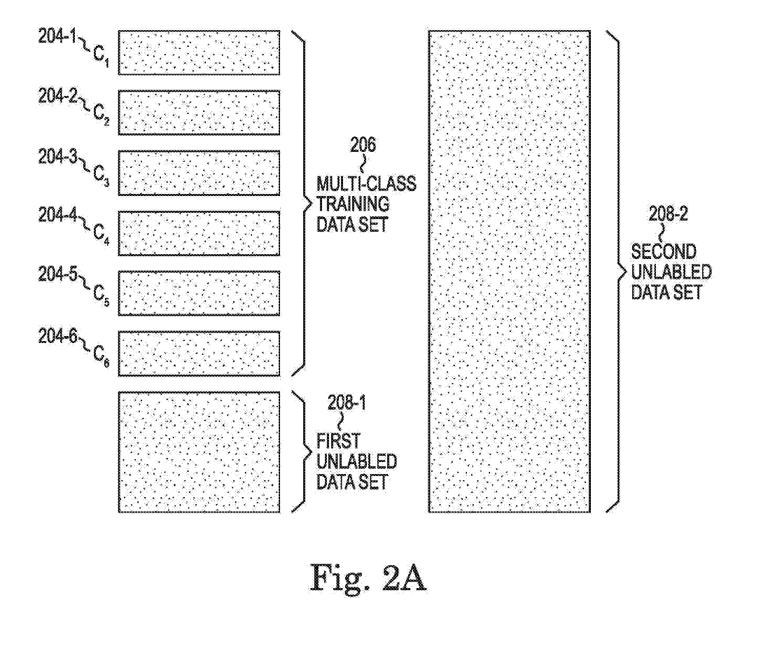

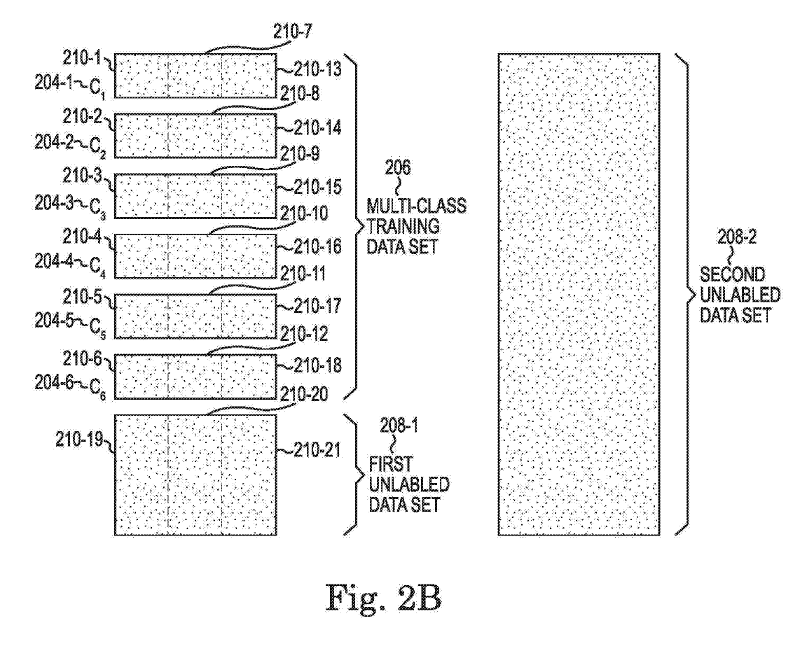

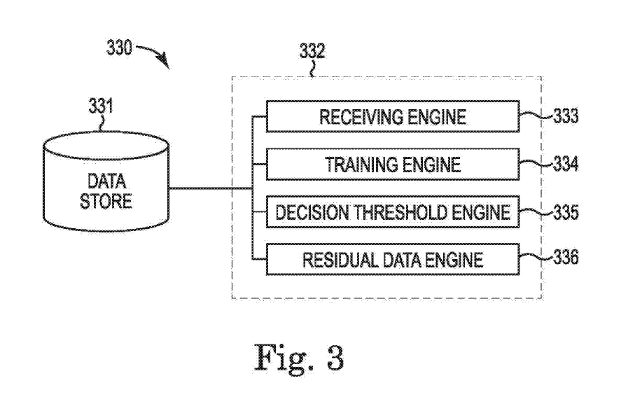

FIG. 1 illustrates a block diagram of an example of a computing device 1 according to the present disclosure. The computing device 138 can include a processing resource 139 connected memory resource 142, e.g., a computer-readable medium (CRM), machine readable medium (MRM), database, etc. The memory resource 142 can include a number of computing modules. The example of FIG. 1 shows a receiving module 143, a labeling module 144, a training module 145, and an application module 146. As used herein, a computing module can include program code, e.g., computer executable instructions, hardware, firmware, and/or logic, but includes at least instructions executable by the processing resource 139, e.g., in the form modules, to perform particular actions, tasks, and functions described in more detail herein in reference to FIG. 2A and FIG. 2B. The processing resource 139 executing instructions associated with a particular module, e.g., modules 143, 144, 145. and 146, can function as an engine, such as the example engines shown in FIG. 3.

FIG. 2A illustrates a diagram of an example of a number of datasets, according to the present disclosure. FIG. 2B illustrates a diagram of an example of a number of data sets according to the present disclosure. In FIG. 2A and FIG. 2B, the plurality of data sets can be operated upon by the modules of FIG. 1 and the engines of FIG. 3.

FIG. 3 Illustrates a block diagram of an example of a system g for residual data identification according to the present disclosure. The system 330 can perform a number of functions and operations as described in in FIG. 2A and FIG. 2B, e.g., labeling residual data instances. The system 330 can include a data store 331 connected to a system, e.g., residual data identification system 332. In this example the residual data identification system can include a number of computing engines. The example of FIG. 3 shows a receiving engine 333, a training engine 334, a decision threshold engine 335, and a residual data engine 336. As used herein, a computing engine can include hardware, firmware, logic, and/or executable instructions, but includes at least hardware to perform particular actions, tasks and functions described in more detail herein in reference to FIG. 2A and FIG. 2B.

The number of engines 333, 334, 335, and 336 shown in FIG. 3 and/or the number of modules 143, 144, 145, and 146 shown in FIG. 1 can be sub-engines/modules of other engines/modules and/or combined to perform particular actions, tasks, and functions within a particular system and/or computing device. For example, the labeling module 144 and the training module 146 of FIG. 1 can be combined into a single module.

Further, the engines and/or modules described in connection FIGS. 1 and 3 can be located in a single system and/or computing device or reside in separate distinct locations in a distributed ruling environment, e.g., cloud computing environment. Embodiments are not limited to these examples.

FIG. 2A includes a multi-class training data set 206, a unlabeled data set 208-1, and a second unlabeled data set 208-2, The multi-class training data set 206 and the first unlabeled data set 208-1 can be used to train a classifier that identifies residual data instances,

The multi-class training data set 206 includes a plurality of data instances, e.g., shown as dots. The multi-class training data set 206 can be received by the receiving module 143 in FIG. 1 or the training engine 333 in FIG. 3. The labeling module 144 can label the plurality of data instances in the multi-class training data set 206 as belonging to a category 204-1 a category 204-2 a category 204-3, a category 204-3, a category 204-4, a category 204-5, and/or a category 204-6, e.g., referred to generally as categories 204. In a number of examples, the multi-class training data set 206 can include more or fewer categories than those shown n FIG. 2A. In a number of examples, the multi-class training data set 206 does not include residual data and/or data instances that have not been labeled as belonging to a category.

As used herein a data instance includes tokens, text, strings, characters, symbols, objects, structures, and/or other representations. A data instance is a representation of a person, place, thing, problem, computer programming object, time, data, or the like. For example, a data instance can represent a problem that is associated with a product, a web page description, and/or a statistic associated with a website, among other representations of a data instance. The data instance can describe the problem via text, image, and/or a computer programming object.

For example, a user of a web site that experiences a problem using the website can fill out a form that includes a textual description and a number of selections that describe the problem. The form, the textual description, and/or the number of selections that describe the problem can be examples of data instances. Furthermore, the form, the textual description, and/or the number of selections can be represented as computer programming objects which an be examples of data instances.

The data instances can be created manually and/or autonomously. The data instances can be included in a multi-class training data set 206, a first unlabeled data set 208-1, and/or a second unlabeled data set 208-2.

The categories 204 describe a correlation between at least two data instances. For example, the category 204-1 can be a type of problem, an organizational structure, and/or a user identifier among other shared commonalities between data instances. For example, the category 204-1 can be a networking problem identifier that describes a specific network problem that is associated with a particular product. Data instances that describe the specific network problem can be labeled as belonging to the category 204-1. The categories 204 do not include residual data instances.

Recognized categories are defined as the categories of the multi-class training data set 206. The data instances multi-class training data set 206 can be labeled as belonging to categories 204 autonomously, e.g., by labeling module 144, and/or by a user. For example, the data instances in the multi-class training data. set 206 can be hand-labeled. A user that associates data instances with categories 294 creates a multi-class training data set 288 that has been manually labeled by a user as opposed to being autonomously labeled. Furthermore, hand-labeled data is data that has had a number of labels confirmed by a user, Predefined classifiers can be applied to divide the data in instances into the categories 204. That is, predefined classifiers can be used to autonomously label data instances.

The first unlabeled data set 208-1 can be received by the receiving module 143 in FIG. 1 or the receiving engine 333 in FIG. 3. The first unlabeled data set 208-1 includes residual data instances. The first unlabeled data set 208-1 may or may not include some data instances that belong in one of the categories 204. It is unknown whether the data instances in the first unlabeled data set 208-1 belong to e of the categories 204 at the time that the first unlabeled data set 208-1 is received by the receiving module 143 in FIG. 1. The first unlabeled data set 208-1 is referred to as unlabeled because the data instances in the first unlabeled data set 208-1 have not been labeled as belonging t the categories 204 and/or labeled as residual data instances as opposed to the data instances in the multi-class training data set 206 that labeled.

The first unlabeled data set 208-1 and/or the multi-class training data set 206 can include data instances that are received in a first time period. For example, the first unlabeled data set 208-1 and/or the multi-class training data set 206 can include data instances that describe problems that were encountered with relation to a particular product in a first month.

The second unlabeled data set 208-2 can be received by the receiving module 143 in FIG. 1 or the receiving engine 333 in FIG. 3. The second unlabeled data set 208-2 includes a plurality of data instances sole of which subsequently may be labeled by the trained classifier as residual data. The second unlabeled data set 208-2 includes residual data instances and/or data instances that<belong in one of the categories 204. The second unlabeled data set 208-2 can be received at a second time period. For example, the second unlabeled data set 208-2 can be problems that are reported during a second month.

The plurality of data instances in the multi-class training, data set 206 and the plurality of data instances in the first unlabeled data set 208-1 can be labeled as positive or negative instances by the labeling module 144 in FIG. 1. The positive data instances or negative data instances labels applied to the data, instances in the multi-class training data set 206 and the first unlabeled data set 208-1 can be used in training the classifier by the training module 45 in FIG. 1 or the training engine 334 in FIG. 3.

The plurality of data instances in the multi-class training data set 206 can be labeled as negative data instances. Labeling the plurality of data instances in the multi-class training data set 206 as negative data instances can replace the labels that identify the plurality of data instances in the multi-class training data set 206 as belonging to the categories 204. Negative data instances can represent data instances that are not residual data instances.

The plurality of data instances in the first unlabeled data 208-1 can be labeled as positive data instances. Positive data can represent data instances that the classifier uses to model residual data instances. A classifier models residual data instances by creating representation of attributes that positive data instances share.

The data instances in the first unlabeled data set 208-1 can be labeled as positive data instances regardless of whether the data instances are residual data or whether the data instances belong to the categories 204. That is, the classifier can use data instances that include residual data and/or non-residual data to identify residual data in the second unlabeled data set 208-2. Non-residual data can include data instances that are not residual data, which include data instances that belong to the categories 204.

The training module 45 in FIG. 1 or the training engine 334 in FIG. 3 can train a classifier using the labeled negative data instances and the labeled positive data instances. The classifier can be a binary classifier, such as a Naïve Bayes classifier, decision tree classifier, Support Vector Machine classifier, or any other type of classifier. The classifier, once trained, can identify residual data. That is the classifier can identify data that does not belong to the categories 204.

The receiving module 143 in FIG. 1 or the receiving engine 333 in FIG. 3 can receive the second unlabeled data set 208-2. An application module 146 in FIG. 1 or a residual data engine 336 in FIG. 3 can apply the classifier to identify residual data instances in the second unlabeled data set 208-2. The classifier can be applied to the data instances in the second unlabeled data set 208-2 that are provided to the classifier as input. In a number of examples, the classifier can assign a score to each of the data instances. The score can define a level of certainty that a given data instance is residual data In a number of examples, the classifier n rank the number of data instances in the second unlabeled data set 208-2 and identify a predetermined number of data instances as residual data. In a number of examples, the classifier can identify whether a given data instance is residual data.

In a number of examples, a new category can be suggested and/or created based on the application of a clustering method to the identified residual data instances. A known-manner clustering method, such as the K-Means algorithm, can identify subgroups of the residual data instances that share similarities. A subset of the residual data instances that share the similarities can be included in a new category. A newly created category can represent similarities between data instances and can include the residual data instances that share the similarities. The residual data instances that belong to the newly created category are labeled as belonging to the newly created category and are no longer labeled as residual data instances. In a number of examples, the data instances that belong to the newly created category can be included in the multi-class training data set 206, which be used to train future classifiers that identify residual data instances.

In a number of examples, the application module 146 in FIG. 1 or the residual data engine 336 in FIG. 3 can apply the classifier to identify residual data instances in the first unlabeled data set 208-1. The data instances in the first unlabeled data set 208-1 that are not identified as residual data can be removed from the first unlabeled data set 208-1 such that only remaining data instances the first unlabeled data set 208-1 are treated as residual data instances. That is, data instances that belong to the categories 204 can be removed from the plurality of data instances in the first unlabeled data set 208-1. Data instances that belong to the categories 204 can be identified by the process of elimination. For example, data instances that are not labeled as residual data by a classifier can be labeled as belonging to the categories 204 without knowing which data instances belong to whit the categories 204. Removing data instances that belong to the categories 204 from the first unlabeled data set 208-1 can further define positive data instances.

The remaining residual data instances that have not been removed from the first unlabeled data set 208-1 can be labeled as positive data instances by a labeling module 144 in FIG. 1. A training module 145 in FIG. 1 or a training engine 334 in FIG. 3 can train a second classifier using the negative data instances and the newly labeled positive data instances. An application module 146 in FIG. 1 or a residual data engine 336 in FIG. 3 can apply the second classifier to identify residual data in the second unlabeled data set 208-2. Applying the second classifier to identify residual data in the second unlabeled data set 208-2 can increase the accuracy in identifying residual data over the application of the first classifier o identify residual data in the second unlabeled data set 208-2 because the second classifier includes a more accurate model of residual data than the first classifier. The second classifier includes a more accurate model of residual data than the first classifier because the positive data instances used to train the second classifier only include residual data instances while the positive data instances used to train the first classifier include residual data instances and/or non-residual data instances.

In a number of examples, a classifier that identifies residual data instances n be composed of an ensemble of classifiers. The ensemble of classifiers can identify residual data instances based on a majority vote of the ensemble of classifiers. Each classifier in the ensemble of classifiers can be trained on a subset of labeled positive data instances and labeled negative data instances. The use of an ensemble of classifier to identify residual data instances is further described with respect to FIG. 2B.

Using a classifier to identify residual data instances can be more accurate for identifying residual data instances than in a number of predefined classifiers that identify data instances that belong the categories 204 and considering a remainder of the data instances to be residual data instances. Each of the predefined classifiers can be trained to identify data instances that belong to one of the categories 204. However, identifying data instances that belong to one of the categories 204 does not identify whether the other data instances are residual data For example, a predefined classifier that identifies data instances that belong to the category 204-1 can provide a score that provides a level of certainty that a data instance belongs o the category 204-1 or that the data instance belongs to some other category of multi-class training data set 206. However, the predefined classifier does not identify whether the data instance belongs to the residual data. Using a classifier that is trained to identify residual data can be more accurate for identifying residual data instances than using a number of predefined classifiers to identify residual data.

FIG. 2B includes a multi-class training data set 206, a first unlabeled data set 208-1, and a second unlabeled data set 208-2 that are analogous to the multi-class training data set 206, the first unlabeled data set 208-1, and the second unlabeled data set 208-2 in FIG. 2A, respectively.

The receiving engine 333 in FIG. 3 or the receiving module 143 in FIG. 1 can receive a plurality of data instances in the multi-class training data set. The multi-class training data set 208 can include data instances that belong to a category 4-1, a category 204-2, category 204-3, a category 204-4, a category 204 , and a category 204-6, e.g., referred to generally as categories 204. The categories 204 are analogous to the categories 204 in FIG. 2A.

The multi-class training data set 206 also includes a number of sections that further divide the data instances. For example, the data instances in the multi-class training data set 206 can be divided into a section 210-1, a section 210-2, a section 210-3, a section 210-4, a section 210-5, a section 210-6, a section 210-7, a section 210-8, a section 210-9, a section 210-10, a section 210-11, section 210-12, a section 210-13, a section 210-14, a section 210-15, a section 210-16, a section 210-17, and a section 210-18.

The receiving engine FIG. 3 or the receiving module 143 in FIG. 1 can receive a plurality of data instances in the first unlabeled data set 2 The data instances in the first unlabeled data set 208-1 can be divided into a section 210-19, a section 210-20, and a section 210-21. The sections in the multi-class training data set 206 and the in the first unlabeled data set 208-1 are referred to generally as sections 210, The multi-class training data set 206 and/or the first unlabeled data set 208-1 can be divided into more or fewer sections than those described herein.

As used herein, a section can include a subset of the data antes that belong to a category. Sections are used to divide data instances within the categories 204. Sections can be used to a plurality of classifiers with different data instances. For example, the section 210-1 can be a first subset of the data instances in category 204-1 the section 210-7 can be a second subset of the data it stances in category 204-1, and the section 210-13 can be a third subset of the data instances in category 204-1.

The training engine 334 in FIG. 3 or the training module 145 in FIG. 1 can train a plurality of classifiers to identify residual data instances. For example, the training engine 334 in FIG. 3 or the training module 145 in FIG. 1 can train a first classifier, a second classifier, and a third classifier to identify residual data instances. or fewer classifiers can be trained to identify residual data instances. The first classifier, the second classifier, and the third classifier referred to in FIG. 2B are different than the first classifier and the second classifier referred to in FIG. 2A because the first classifier, the second classifier, and the third classifier referred to in FIG. 2B can collectively identify residual data instances while the first classifier and the second classifier referred to in FIG. 2A independently identify residual data instances. That is a first classifier or a second classifier in FIG. 2A can consist of a first classifier, a second classifier, and a third classifier as described in FIG. 2B.

The first classifier, the second classifier, and/or the third classifier can be independent from each other. The data instances used to train the first classifier can be different than the data instances used to train the second classifier and/or the third classifier. In a number of examples, the data instances used to train the first classifier can be used rain the second classifier and/or the third classifier.

Each of the classifiers that identify residual data instances be trained using one more of the plurality of sections, e.g., section 210-1 through section 210-18, of the plurality of data instances in the training data set 206 as negative data instances. Each of the classifiers that identify residual data instances can be trained using one or more of first sections, e.g., section 210-19 through section 210-21, of the plurality of data instances in the first unlabeled data set 208-1 as positive data instances.

For example, an n-fold cross validation method can be used to train the plurality of classifiers. In the examples given in FIG. 2B, 3-fold cross validation is used to train the three classifiers using three different groupings of section 210-1 through section 210-19, and, three different groupings of section 210-19 through section 210-21. However, for example, 10-fold cross validation can be used among other variations of n-fold cross validation. The letter “n” in n-fold cross validation represents the number of classifiers that are trained to identify residual data and/or the number of sets of data that are used to train the number of classifiers The data instances in section 210-1 through section 210-12 can be used as negative data instances to train a rust classifier that identifies residual data instances. The data instances in section 210-7 though section 210-18 can be used as negative data instances to train a second classifier that identifies residual data instances. The data instances in section 210-13 through section 210-18 and section 210-1 through section 210-6 can be used as negative data instances to train a third classifier that identifies residual data instances. The data instances in section 210-19 and section 210-20 can be used as positive data instance to train the first classifier. The data instances in section 210-20 and section 210-21 can be used as positive data instances to train the second classifier. The data instances in section 210-21 and section 210-19 can be used as positive data instances to train the third classifier.

A decision threshold engine 335 in FIG. 3 can set a decision threshold for each of the plurality of classifiers based on one of the plurality of second sections, e.g., section 210-19 through section 210-1, of the plurality of data instances in the first unlabeled data set 208-1 The plurality of second sections can include the same sections, e.g., section 210-19 through section 210-21, as the plurality of first sections because any given classifier only uses data instances in a portion of the available sections as positive data instances. Data instances in the remaining portion of the available sections are used to set the decision threshold.

For example, a first grouping of the plurality of first sections can include the section 210-19 and section 210-20. The first grouping of the plurality of first sections can be used to train the first classifier. The remaining section, e.g., section 210-21, can be included in the plurality of second sections. A second grouping of the plurality of first sections can include section 210-20 and section 210-21. The second grouping of the plurality of first sections can be used to train the second classifier. The remaining section, e.g., section 210-19, can be included in the plurality of second sections. A third grouping of the plurality of first sections can be included in section 210-19 and section 210-21. The third grouping of he plurality of first sections can be used to train the third classifier. The remaining section, e.g., section 210-20, can be included in the plurality of rid sections. That is, the plurality of first sections an include the action 210-19 and the section 210-20, the section 210-20 and the section 210-21, and the section 210-19 and the section 210-21. The plurality of second sections can include the section 210-19, the section 210-20, and the section 210-21.

Data instances in the section 210-21 can be used to set a first decision threshold for a first classifier if data instances in the section 210-19 and the section 210-20 are used as positive data instances in training the first classifier. Data instances in the section 210-19 can be used to set a second decision threshold for a second classifier data instances in the section 210-20 and the section 210-21 are used as positive data instances in training the second classifier. Data instances in the section 210-20 can be used to set a third decision threshold for a third classifier if data instances in the section 210-19 and the section 10-21 are used as positive data instances in training the third classifiers.

A decision threshold can be set such that a predefined percentage of data instances in an associated section from the plurality second sections are identified by an associated classifier as dual data instances. For example, given that the data instances in the section 210-19 and the section 210-20 are used as positive data instances, then the data instances in the section 210-21 can be used to set the decision threshold for a given classifier. The given classifier can give a score to a data instance that can be used to determine whether the data instance is residual data. The plurality of data instances in the section 210-13 through the section 210-18 can be ranked based on a score that is given by the given classifier to each of the plurality of data instances. A decision threshold can be a number that coincides with the ore such that a predefined percentage of the plurality of scores re below the decision threshold. For example, given that there are 100 data instances in the section 210-13 through the section 210-18, that each of the 100 data instances are given a score, and that the predefined percentage is set at 98 percent, then a decision threshold can be set such that 98 percent of the scores, and as a result 98 percent of the associated data instances, are below the decision threshold. The data instances hat have an associated score that falls below the decision threshold can be identified as non-residual data instances by the given classifier. The data instances that have an associated score that falls above the decision threshold can be identified as residual data instances by the given classifier.

In a number of examples, a bagging method can be used to train the plurality of classifiers. A bagging method can use a randomly selected plurality of data instances from each section, e.g., section 210-1 through section 210-18, in the multi-class training data set 206 as negative data instances. The bagging method can use data instances in a randomly selected plurality of section, e.g., section 210-19 through section 210-21, in the first unlabeled data set 208-1 as positive data instances. A decision threshold can be set such as defined above using the unselected data instances from the multi-class training data set 206 given classifiers that are trained using the bagging method.

The residual data engine 336 in FIG. 3 and the application module 148 in FIG. 1 can identify data instances as residual data when a majority of the plurality of classifiers identify the data instances as residual data. For example, given that three classifiers are trained using the examples given in FIG. 2B, then each of the three classifiers can identify each of the plurality of data instances in the second unlabeled data set 208-2 as residual data or non-residual data.

For example, a first classifier can identify a data instance as residual data, a second classifier can identify the data instances as residual data, and a third classifier can identify the data instance as non-residual data Each of the identifications given by plurality of classifiers can be said to be a vote. For example, the first classifier classifier can vote that the data instance is residual data, the second classifier can vote that the data instance is residual data, and the third classifier can vote that the data in a e is non-residual data. A majority of the votes, and/or a majority of the identifiers given by the plurality of classifiers can be used to label the data instance as residual data. The classifiers can be used to collectively label data instances using a different combination of the classifiers and/or different measures given by the classifiers.

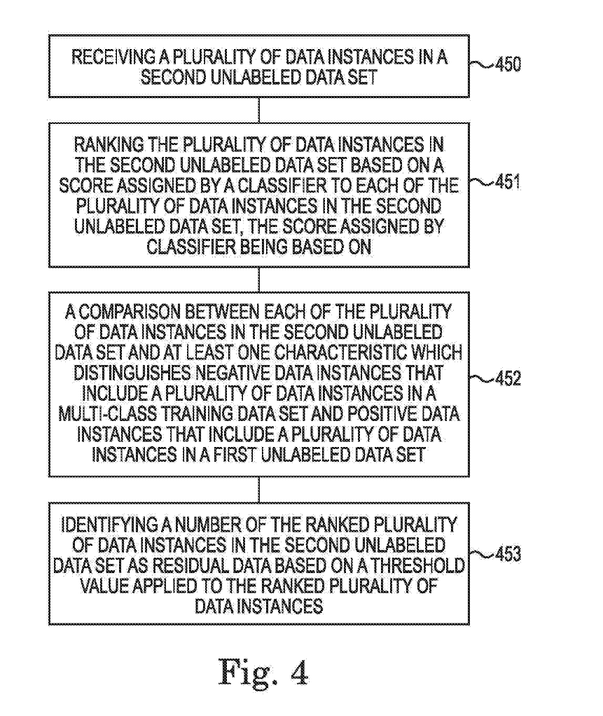

FIG. 4 illustrates a flow diagram of an example of a method for residual data identification according to the present disclosure. At 450, a plurality of data instances in a second unlabeled data set can be received. The second unlabeled data set can be second as compared to a first unlabeled data set. The use of first and second with relation to the unlabeled data sets does not imply order but is used to conform to naming conventions used in FIGS. 2A and 2B.

At 451, the plurality of data instances in the second unlabeled data set can be ranked. The ranking can be based on a score assigned by a classifier to each of the plurality of data instances in the second unlabeled data set.

At 452, each of the plurality of data instances in the second unlabeled data set can be compared to at least one of a plurality of characteristics which distinguishes negative data instances that include a plurality of data instances in a multi-class training data set and positive data instances that include a plurality of data instances in the first unlabeled data set. The plurality of data instances in the second unlabeled data set can be compared to the characteristics of the negative data instances and the positive data instances to score each of the plurality of data instances in the second unlabeled data set. A score can describe a similarity between a data instances and the positive data instances and/or the negative data instances. For example, a high score can indicate that a data instance shares more similarities with the positive data instances than the negative data instances. A comparison can be a means of producing the score using a trained model and a data instance.

In a number of examples, a classifier can include a model of the positive data instance and the negative data instances. The training module 145 in FIG. 1 and the training engine 334 in FIG. 3 can train the classifier by creating a model which can be referred to herein as a trained model. A model can describe a plurality of characteristics associated with the negative data instances and a plurality of characteristics associated with the positive data instances.

At 453, a number of the ranked plurality of data instances in the second unlabeled data set can be identified as residual data based n a threshold value applies to the ranked plurality of data instances. A threshold value can be used to determine which of the ranked plurality of data instances are identified as residual data and/or non-residual data. For example, if a threshold value is 0.75, then data instances with a score equal to and/or higher than 0.75 can be identified at residual data. In a number of examples, a threshold value can define a number of the plurality of data instances that are residual data. For example, if a residual value is 10, then the 10 data instances with the highest more can be identified as residual data.

The threshold value can be pre-defined and/or or set by a quantification technique. A pre-defined threshold value is a threshold value that is hand selected and/or a threshold value that does not change. For example, a pre-defined threshold value can be selected during the training of a classifier, before the training of the classifier, and/or after the training of the classifier by a human user.

A quantification technique can provide a number of expected data instances that have a potential for being identified as residual data instances. A quantification method can predict a number of data instances that should be identified as residual data and/or a percentage of the data instances in the second unlabeled data set that, should be identified as residual data. For example, a quantification method can predict that a second unlabeled data set includes 400 residual data instances. A threshold value can then be set so that 400 data instances in the second unlabeled data set are selected as residual data. Similarly, if a quantification method predicts that 5 percent of the data instances in the second unlabeled data set should be identified at residual data, then a threshold value can, be set such that 5 percent of the ranked data instances in the second unlabeled data set are identified as residual data. A quantification technique can use the multi-class training data set and/or the first and second unlabeled data sets to create a prediction. The prediction can be based on the number of residual data instances observed in the first unlabeled data set as compared to the n-residual data instances observed in the multi-class training data set and/or the first unlabeled training data set.

The threshold value is selected to comprise a threshold level that satisfies at least one condition. The possible conditions include selecting the threshold value to substantially maximize a difference between the true positive rate (TPR) and the false positive rate (FPR) for the classifier, so that the false negative rate (FNR) is substantially equal to the FPR for the classifier, so that the FPR is substantially equal to a fixed target value, so that the TPR is substantially equal to a fixed target value, so that the difference between a raw count and the product of the FPR and the TPR is substantially maximized, so that the difference between the TPR and the FPR is greater than a fixed target value, so that the difference between the raw count and the FPR multiplied by the number of data instances in the target set is greater than a fixed target value, and based on a utility and one or more measures of behavior. As used herein, substantially indicates within a predetermined level of variation. For example, substantially maximizing a difference includes maximizing a difference beyond a predetermined difference value. Furthermore, substantially equal includes two different values that differ by less than a predetermined value.

In a number of examples, the selected threshold level worsens the ability of the classifier to accurately classify the data instances. However, the accuracy in the overall count estimates the data instances classified into a particular category is improved. In addition, the classifier employs the selected threshold value, along with various other criteria to determine whether the data instances are residual data or non-residual data. Moreover, one or both of a count and an adjusted count of the number of data instances that are residual data are computed.

In a number of examples, multiple intermediate counts are computed using a plurality of alternative threshold values. Some of the intermediate counts are removed from consideration and the median, average, or both, of the remaining intermediate counts are determined. The median, average, or both of the remaining intermediate counts are then used to calculate an adjusted count. Using the quantification technique describe herein, the data instances in the second unlabeled data set n be identified as residual data or non-residual data.

What is claimed:

1. A non-transitory machine-readable medium storing instructions for residual data identification executable by a machine to cause the machine to:
receive a plurality of data instances in a multi-class training data set that are labeled as belonging to recognized categories;
receive a plurality of data instances in a first unlabeled data set;
label the plurality of data instances in the multi-class training data set as negative data instances;
label the plurality of data instances in the first unlabeled data set as positive data instances;
train a classifier with the labeled negative data instances and the labeled positive data instances;
receive a plurality of data instances in a second unlabeled data set; and
apply the classifier to identify residual data instances in the second unlabeled data set.

2. The medium of claim 1, wherein the residual data instances are data instances that do not belong to any recognized categories.

3. The medium of claim 1, including instructions to suggest a new category based on an application of a clustering method to the identified residual data instances.

4. The medium of claim 1, including instructions to:
apply the classifier to identify residual data instances in the first unlabeled data set;
remove a data instance from the plurality of data instances in the first unlabeled data set such that only remaining data instances in the first unlabeled data set are treated as residual data instances.

5. The medium of claim 4, including instructions to:
label the residual data instances in the first unlabeled data set as the positive data instances;
train a second classifier with the negative data instances and the positive data instances;
apply the second classifier to identify residual data in the second unlabeled data set.

6. The medium of claim 1, wherein the classifier is an ensemble of classifiers that identifies residual data instances based on a majority vote of the ensemble of classifiers.

7. The medium of claim 6, wherein each classifier in the ensemble of classifiers is trained on a subset of labeled positive data instances and labeled negative data instances.

8. A system for residual data identification comprising a processing resource in communication with a non-transitory machine readable medium having instructions executed by the processing resource to implement:
a receiving engine to:
receive a plurality of data instances in a multi-class training data set, the plurality of data instances in the multi-class training data set belonging to a plurality of recognized categories;
receive a plurality of data instances in a first unlabeled data set; and
receive a plurality of data instances in a second unlabeled data set;
a training engine to train a plurality of classifiers to identify data instances using:
a plurality of sections of the plurality of data instances in the multi-class training data set as negative data instances; and
a plurality of first sections of the plurality of data instances in the first unlabeled data set as positive data instances;
a decision threshold engine to set a decision threshold for each of the plurality of classifiers based on one of a plurality of a second sections of the plurality of data instances in the first unlabeled data e and
a residual data engine to identify residual data from the second unlabeled data set using a combination of the plurality of classifiers

9. The system of claim 8, including the training engine to train the plurality of classifiers using a majority vote output by a subset of classifiers, each of the subset of classifiers is trained on subsets of available negative data instances and positive data instances according to an n-fold cross validation method.

10. The system of claim 8, including the training engine r the plurality of classifiers using the plurality of first sections of the plurality of data instances in the multi-class training data set and the plurality of first sections of the plurality of data instances in the first unlabeled data set according to, a bagging method.

11. The system of claim 8, including the decision threshold engine to:
use a different third section of the plurality of data instances to set each of the decision thresholds; and
set each of the decision thresholds such that a predefined percentage of data instances in an associated section from the plurality of second sections are identified by an associated classifier as non-residual data instance.

12. The system claim 8, including the residual data engine to identify a data instance as residual data when a majority of the plurality of classifiers identify the data instance as residual data.

13. A method for residual data identification comprising:
receiving a plurality of data instances in a second unlabeled data set;
ranking the plurality of data instances in the second unlabeled data set based on a score assigned by a classifier each of the plurality of data instances in the second unlabeled data set, wherein the score assigned by classifier is based on:
a comparison between each of the plurality of data instances in the second unlabeled data set and at least one characteristic which distinguishes negative data instances that include a plurality of data instances in a multi-class train g data set and positive data instances that include a plurality of data instances in a first unlabeled data set; and
identifying a number of the ranked plurality of data instances in the second unlabeled data set as residual data based on a threshold value applied to the ranked plurality of data instances.

14. The method of claim 14, wherein the threshold value applied to the ranked plurality of data instances is set by a quantification technique applied to the multi-class training data set and the first unlabeled data set.

15. The method of claim 15, wherein the threshold value applied to the ranked plurality of data instances is a pre-defined threshold value.
